(19) United States
(12) Patent Application Publication
(10) Pub. No.: US 2008/0047382 A1
(43) Pub. Date: Feb. 28, 2008

(54) STEERING APPARATUS

(75) Inventors: Masaki Tomaru, Maebashi-shi (JP); Kouhei Yonezawa, Kashiwa-shi (JP); Hiroyuki Muramatsu, Maebashi-shi (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 11/843,760

(22) Filed: Aug. 23, 2007

(30) Foreign Application Priority Data
Aug. 24, 2006 (JP) 2006-228473

(51) Int. Cl. F16H 35/00; B62D 1/18

(52) U.S. Cl. 74/388 PS; 74/493

(57) ABSTRACT

In the steering apparatus and feed screw mechanism, by properly adjusting the screw-in distance of a pressing force adjusting screw 77, the arc-shaped contact surface 761 of a pressing member 76 can be pressed against the outer diameter portion 711 of a feed screw shaft 71 with a required pressing force due to the biasing force of a compression coil spring 78. As a result of this, a backlash between a feed nut 73 and feed screw shaft 71 can be removed. Therefore, the telescopic position adjustment and tilt position adjustment of a steering wheel 3 can be carried out smoothly, thereby being able to enhance the rigidity of the steering wheel 3 after execution of the position adjustment thereof.

The present invention claims foreign priority to Japanese patent application No. 2006-228473, filed on Aug. 24, 2006, the contents of which is incorporated herein by reference.

### BACKGROUND OF THE INVENTION

1. Field of the Invention

The present invention relates to a steering apparatus and, specifically, the invention relates to a steering apparatus which can adjust the tilt position or telescopic position of a steering wheel using the feed movement of a feed screw mechanism, and a feed mechanism used in the steering apparatus.

2. Description of Related Art

In a steering apparatus, it is necessary to adjust the tilt position or telescopic position of a steering wheel according to the build or driving attitude of a driver. There is known a steering apparatus including a feed screw mechanism which adjusts the tilt position or telescopic position by rotating a feed screw shaft through the rotation of an electric motor to thereby move linearly a feed nut threadedly engaged with the feed screw shaft.

In a conventional feed screw mechanism used in such steering apparatus, as shown in PCT International Publication WO03/078234, there is removed a backlash between the feed screw shaft and feed nut to thereby carry out a smooth feeding operation.

FIG. 8 shows a feed mechanism disclosed in the WO03/078234. That is, FIG. 8 shows a main portion of the feed screw mechanism disclosed in the WO03/078234. Specifically, FIG. 8A is an enlarged front view of the feed screw mechanism and FIG. 8B is a section view, taken along the B-B line shown in FIG. 8A. As shown in FIGS. 8A and 8B, the feed screw mechanism disclosed in the WO03/078234 includes a feed screw shaft 81 and a feed nut 82 which are threadedly engaged with each other and, on the feed nut 82, there is provided a ball 83 having a spherical-shaped projection in such a manner that it is formed integral with the feed nut 82. This ball 83 is fitted with a sleeve provided on the movable side of a steering apparatus to thereby constitute a spherical joint; and, by moving the feed nut 82 linearly, the tilt position or telescopic position of a column (not shown) can be adjusted.

The feed nut 82 includes a slit 84 which is formed at a position of which phase is shifted by 180 degrees relative to the ball 83 and extends parallel to the feed screw shaft 81. A bolt 85, which is used to adjust the clearance of the slit 84, is screwed into the feed nut 82 from a direction intersecting at right angles to the slit 84.

By screwing the bolt 85 to adjust the clearance of the slit 84, the backlash between the feed nut 82 and feed screw shaft 81 can be adjusted. However, in the feed screw mechanism disclosed in the WO03/078234, it is necessary to adjust the backlash between the feed nut 82 and feed screw shaft 81 to a proper value.

Also, when pitch dimension of the feed screw shaft 81 and feed nut 82 varies among the axial direction positions thereof, the backlash between the feed nut 82 and feed screw shaft 81 is not constant but varies. For this reason, it is necessary to manufacture thread ridges of the feed screw shaft and feed nut with high precision. Further, when the thread ridges of the feed screw shaft and feed nut are wore out, the backlash between them increases according to the degree of wear thereof.

### SUMMARY OF THE INVENTION

It is an object of the invention to provide a steering apparatus which can facilitate the adjustment of a backlash between a feed screw shaft and a feed nut and, even when the thread ridges of the feed screw shaft and feed nut provide poor precision, can surely remove the backlash between them to enhance the rigidity of a feed screw mechanism, thereby being able to reduce the manufacturing cost thereof, and a feed screw mechanism incorporated into such steering apparatus.

In order to achieve the above object, according to a first invention, there is provided a feed screw mechanism including:

a feed screw shaft;

a feed nut threadedly engaged with the feed screw and moving relative to the feed screw, the feed nut including:
a penetration hole which penetrates the feed nut in radial direction; and
a female screw formed on an inner peripheral surface of the penetration hole;

a pressing member which is inserted into the penetration hole and abuts with an outer diameter surface of the feed screw;

a pressing force adjusting screw threadedly engaged with the female screw formed in the inner peripheral surface of the penetration hole; and

an elastic member interposed between the pressing force adjusting screw and the pressing member.

According to a second invention, as set forth in the first aspect of the invention, it is preferable that

the pressing member includes an arc-shaped contact surface contactable with the outer diameter portion of the feed screw shaft.

According to a third invention, as set forth in the first aspect of the invention, it is preferable that

the pressing member includes a V-shaped contact surface contactable with the outer diameter portion of the feed screw shaft.

According to a fourth invention, as set forth in the first aspect of the invention, it is preferable that

the pressing member includes contact surfaces contactable with at least two portions of the outer diameter portion of the feed screw shaft.

According to a fifth invention, there is provided a steering apparatus including:

a steering shaft to which a steering wheel is mounted at a vehicle body rear side thereof;

a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;

an electric actuator mounted on the column or on the vehicle body mounting bracket; and

the feed screw mechanism as set forth in the first aspect of the invention,

wherein the feed screw mechanism is driven by the electric actuator for carrying out the tilt movement or telescopic movement of the column by using the relative movement between the threadedly engaged feed screw shaft and feed nut.

According to a sixth aspect of the invention, there is provided a steering apparatus including:

a steering shaft to which a steering wheel is mounted at a vehicle body rear side thereof;

a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;

an electric actuator mounted on the column or on the vehicle body mounting bracket; and

the feed screw mechanism as set forth in the second aspect of the invention,

wherein the feed screw mechanism is driven by the electric actuator for carrying out the tilt movement or telescopic movement of the column by using the relative movement between the threadedly engaged feed screw shaft and feed nut.

According to a seventh aspect of the invention, there is provided a steering apparatus including:

a steering shaft to which a steering wheel is mounted at a vehicle body rear side thereof;

a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;

an electric actuator mounted on the column or on the vehicle body mounting bracket; and

the feed screw mechanism as set forth in the third aspect of the invention,

wherein the feed screw mechanism is driven by the electric actuator for carrying out the tilt movement or telescopic movement of the column by using the relative movement between the threadedly engaged feed screw shaft and feed nut.

According to an eighth aspect of the invention, it is preferable that the steering apparatus as set forth in the seventh aspect of the invention further including:
a spherical-shaped ball formed in the feed nut; and

a cylindrical-shaped sleeve formed in a power transmission path of the tilting movement or telescopic movement from the electric actuator to the column,

wherein the ball is slidably fitted into the sleeve.

According to a ninth aspect of the invention, there is provided a feed screw mechanism including:

a feed screw shaft;

a feed nut threadedly engaged with the feed screw and moving relative to the feed screw, the feed nut including:
a penetration hole which penetrates the feed nut in radial direction; and
a female screw formed on an inner peripheral surface of the penetration hole; and

a pressing member which is inserted into the penetration hole and includes a V-shaped contact surface contactable with the outer diameter portion of the feed screw shaft.

According to a tenth aspect of the invention, there is provided a steering apparatus including:

a steering shaft to which a steering wheel is mounted at a vehicle body rear side thereof;

a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;

an electric actuator mounted on the column or on the vehicle body mounting bracket; and

the feed screw mechanism as set forth in claim 9,

wherein the feed screw mechanism is driven by the electric actuator for carrying out the tilt movement or telescopic movement of the column by using the relative movement between the threadedly engaged feed screw shaft and feed nut.

According to the present invention, there is provided a steering apparatus and a feed screw mechanism provided with: a penetration hole formed in a feed nut in such a manner that it opens in the inner diameter hole formed in a female screw of the feed nut and extends in the radial direction of the feed nut; a pressing member which can be inserted into the penetration hole and has an arc-shaped or V-shaped contact surface to be contacted with the outer diameter portion of the feed screw shaft; a pressing force adjusting screw which is threadedly engaged with a female screw formed in the penetration hole; and, an elastic member interposed between the pressing force adjusting screw and pressing member.

Therefore, a steering apparatus and a feed screw mechanism according to the invention can facilitate the backlash adjusting operation and thus, even when the precision of the thread ridges of the feed screw shaft and feed nut is poor, can positively remove the backlash, whereby the manufacturing cost of the feed screw mechanism can be reduced and the rigidity of the feed screw mechanism can be enhanced.

Also, even when the thread ridges of the feed screw shaft and feed nut wear out, the backlash can be removed following the degree of such wear, thereby being able to enhance the durability of the feed screw mechanism.

### BRIEF DESCRIPTION OF THE DRAWINGS

FIG. 1 is a general perspective view of a motor-driven type steering apparatus of according to the invention, showing a state in which it is mounted on a vehicle;

FIG. 2 is a schematic structure view of the main portions of a steering apparatus of a motor-driven tilting type according to the invention, including a section view in part;

FIG. 3 is a section view, taken along the A-A line shown in FIG. 2;

FIG. 4 is a schematic structure view of the main portions of a steering apparatus of a motor-driven telescopic type according to the invention, including a section view in part;

FIG. 5 is a lower surface view of FIG. 4;

FIG. 6 is a section view of the main portions of a feed screw mechanism according to an embodiment 1 of the invention, corresponding to FIG. 8B;

FIG. 7 is a section view of the main portions of a feed screw mechanism according to an embodiment 2 of the invention, corresponding to FIG. 8B;

FIG. 8A is an enlarged front view of the main portions of a conventional feed screw mechanism; and

FIG. 8B is a section view taken along the B-B line shown in 8A.

### DETAILED DESCRIPTION OF EXEMPLARY EMBODIMENTS OF THE INVENTION

### Embodiments

Now, description will be given below of embodiments 1 and 2 according to the invention with reference to the accompanying drawings.

### Embodiment 1

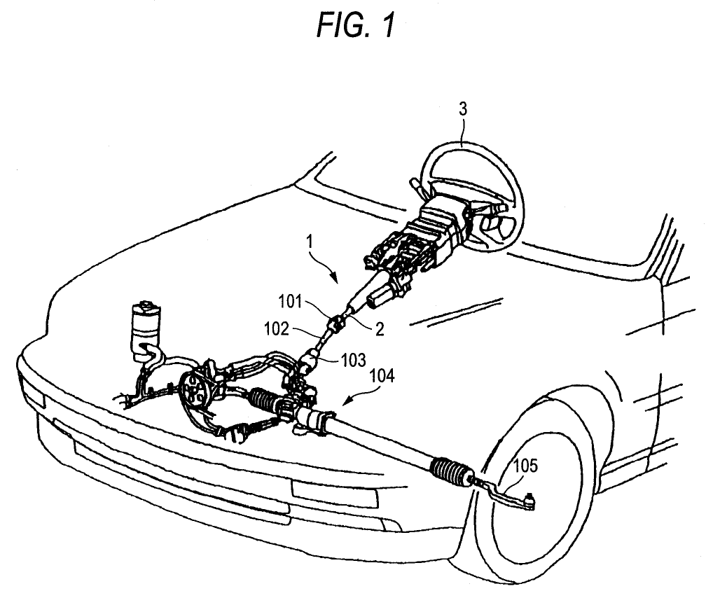

FIG. 1 is a general perspective view of a steering apparatus 1 according to the invention, showing a state in which it is mounted on a vehicle. As shown in FIG. 1, the steering apparatus 1 includes a steering shaft 2 which is rotatably supported. On the right end (on a rear side of a vehicle body) of the steering shaft 2, there is mounted a steering wheel 3 and to the left end (on the front side of a vehicle body) of the steering shaft 2, there is connected an intermediate shaft 102 through a universal joint 101.

To the left end of the intermediate shaft 102, there is connected a universal joint 103 and, to the universal joint 103, there is connected a steering gear 104 which is composed of a rack and pinion mechanism and the like.

When a driver rotationally operates the steering wheel 3, the rotation power of the steering wheel 3 is transmitted through the steering shaft 2, universal joint 101, intermediate shaft 102 and universal joint 103 to the steering gear 104, whereby a tie rod 105 is moved through the rack and pinion mechanism to thereby change the steering angle of a wheel.

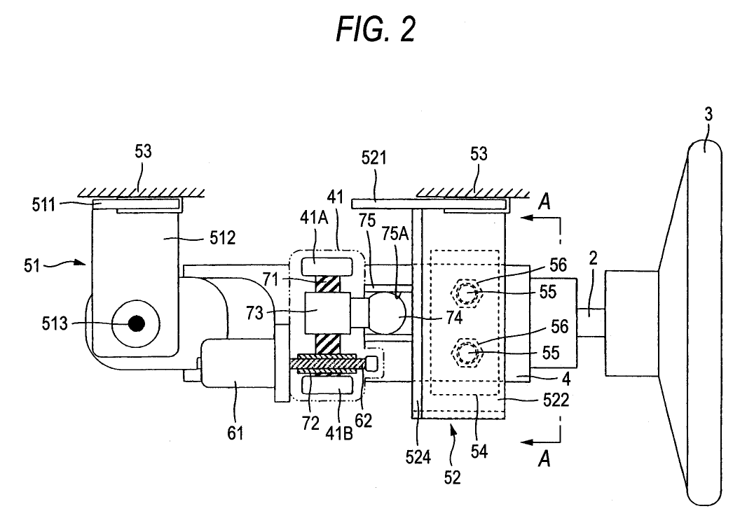

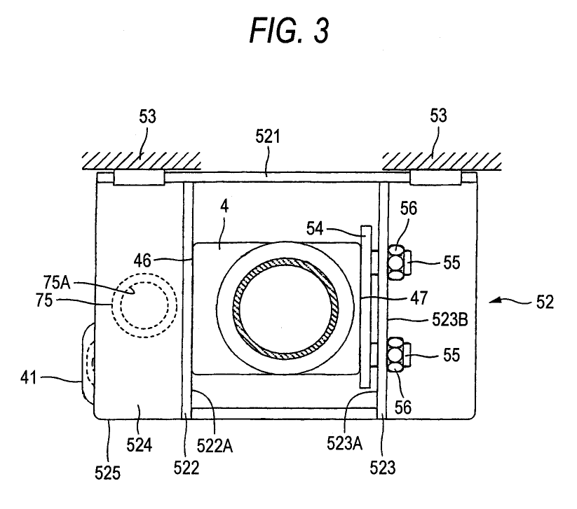

FIG. 2 is a schematic structure view of the main portions of a steering apparatus of an electrically tilting type which adjusts the tilt position of the steering wheel 3 using an electric motor. FIG. 3 is a section view, taken along the A-A line shown in FIG. 2.

On the left side (a front side of a vehicle body) of FIG. 2, a mounting portion 511 formed in the upper portion of a lower vehicle body mounting bracket 51 is fixed to a vehicle body 53, and a pivot portion 512 is extended downwardly from the mounting portion 511. The left end of a column 4 is oscillatably supported on the lower vehicle body mounting bracket 51 while a pivot pin 513 rotatably supported on the pivot portion 512 is used as the fulcrum of the column 4 left end.

On the right side (the rear side of the vehicle body) of FIG. 2, a mounting portion 521 formed in the upper portion of an upper vehicle body mounting bracket 52 is fixed to the vehicle body 53; there are provided side plates 522 and 523 which respectively extend downwardly from the mounting portion 521; and, the right side surface 46 and left side surface 47 of the column 4 are held by and between the inner surfaces 522A and 523A of the side plates 522 and 523 in such a manner that they can be slided in a tilting manner. The steering shaft 2 is rotatably supported on the column 4 and, on the right end (the rear side of the vehicle body) of the steering shaft 2, there is mounted the steering wheel 3.

On the left side surface 46 of the column 4, there is disposed a bracket 41 in such a manner that it is formed integrally with the column 4 left side surface 46 and, to the bracket 41, there is fixed an electric motor 61 which functions as an electric actuator. Also, on the upper rotating support portion 41A and lower rotating support portion 41B of the bracket 41, there are rotatably supported the upper and lower endportions of a feed screw shaft 71, respectively. According to the embodiment of the invention, as an electric actuator, there is used the electric motor 61 of a rotary type; however, there may also be used an actuator of a linear motion type.

The electric motor 61 includes a worm gear 62 which is formed on the output shaft of the electric motor 61 integrally therewith, and a worm wheel 72 fixed to the feed screw shaft 71 is meshingly engaged with the worm gear 62. The worm wheel 72 and worm gear 62 cooperate together in constituting a reduction mechanism, whereby the rotation of the electric motor 61 is transmitted to the feed screw shaft 71 in a reduced manner.

The feed screw shaft 71 is threadedly engaged with a feed nut 73 which converts the rotation of the feed screw shaft 71 to a linear movement. The feed nut 73 can be moved along the feed screw shaft 71 in the vicinity of the axis of the column 71 in the vertical direction in FIG. 2. The feed screw shaft 71 and feed nut 73 cooperate together in constituting a feed mechanism; and, this feed mechanism is a feed screw mechanism which converts the rotation of the feed screw shaft 71 to the linear movement of the feed nut 73.

On the right side of the feed nut 73 in FIG. 2, there is disposed a ball 74 including a spherical-shaped projection in such a manner that the ball 74 is formed integrally with the feed nut 73. A cylindrical-shaped sleeve 75 is formed integrally with the front plate 524 (in FIG. 2) of the upper vehicle body mounting bracket 52; and, the outer periphery of the ball 74 is slidably fitted into the inner periphery 75A of the sleeve 75 to thereby constituting a spherical joint.

As shown in FIG. 3, into a clearance between the right side surface 47 of the column 4 and the inner surface 523A of the right side plate 523 of the upper vehicle body mounting bracket 52, there is inserted a rectangular plate-shaped spacer 54, the thickness of which is smaller than the dimension of the clearance.

Into the right side surface 523 of the upper vehicle body mounting bracket 52, there are screwed two adjusting screws 55, 55 from the outer surface 523B side thereof in such a manner that the two adjusting screws 55 are spaced from each other in the vertical direction (tilt position adjusting direction) in FIGS. 2 and 3.

When the two adjusting screws 55, 55 are screwed in, the spacer 54 can be pressed toward the column 4 (in the left direction in FIG. 3). Even when the clearance between the right side surface 47 of the column 4 and the inner surface 523A of the right side plate 523 is inclined due to a manufacturing error or the like, by adjusting properly the screwing amount of the adjusting screws 55, 55, the spacer 54 can be uniformly contacted with the right side surface 47 of the column 4. Therefore, a tilt sliding resistance between the column 4 and side plates 522, 523 can be set for a desired sliding resistance and also, regardless of a tilt angle, a tilt sliding resistance during a tilting operation can be maintained constant.

When the adjustments of the adjusting screws 55, 55 are completed, lock nuts 56, 56 are screwed into their associated adjusting screws 55, 55 to tighten the lock nuts 56, 56 to the outer surfaces 523B of the side plate 523, thereby preventing the adjusting screws 55, 55 from being loosened.

When there arises the need to adjust the tilt position of the steering wheel 3, if a switch (not shown) is operated, the electric motor 61 is driven and rotated in either of forward or reverse direction. As a result of this, the rotation of the electric motor 61 is transmitted from the worm gear 62 to the worm wheel 72 in a reduced manner to rotate the feed screw shaft 71 formed integral with the worm wheel 72, whereby, for example, the feed nut 73 is lowered in the axial direction along the feed screw shaft 71.

In response to this, the ball 74 formed integral with the feed nut 73 also lowers with respect to the column 4 and, because the ball 74 is fitted with the sleeve 75, the column 4 is moved upwardly. Also, when the ball 74 moves upward, the column 4 is tilt-moved downward. When the column 4 is tilt-moved, the ball 74 is rotated and slided freely within the inner periphery 75A of the sleeve 75, whereby the tilt-movement of the column 4 cannot be blocked and, between the ball 74 and sleeve 75, there cannot be generated unnecessary stress or friction.

As shown in FIGS. 2 and 3, according to the embodiment of the invention, the bracket 41 used to fix the electric motor 61 and the movable-side sleeve 75 to be fitted with the ball 74 are mounted not only on the outside of a tilt-sliding surface between the column 4 and upper vehicle body mounting bracket 52 but also on the side of the left side surface 46 of the column 4. Also, the bracket 41 and sleeve 75 are mounted upwardly of the lower end 525 of the upper vehicle body mounting bracket 52. Thus, since a drive system such as the feed screw mechanism is not disposed on the lower side of the column 4, it is possible to sufficiently secure a space between the knees of the driver and steering apparatus, thereby providing a structure which can effectively prevent the knees of the driver from being collided with the steering apparatus.

In the above-mentioned steering apparatus of an electric tilt type, the electric motor 61 is fixed to the column 4. Alternatively, however, the electric motor 61, feed screw shaft 71 and feed nut 73 may be mounted on the upper vehicle body mounting bracket 52, while the cylindrical-shaped sleeve 75 may be mounted on the column 4.

Also, in the above-mentioned steering apparatus of an electric tilt type, the feed screw shaft 71 is rotated and the rotational movement of the feed screw 71 is converted to the linear movement of the feed nut 73. However, a female screw, which is formed on the inner periphery of the worm wheel 72, may be threadedly engaged with the feed screw shaft 71, the feed nut 73 may be fixed to the feed screw shaft 71, the rotational movement of the worm wheel 72 may be used to move the feed screw shaft 71 linearly, and thus the ball 74 may be moved up and down with respect to the column to thereby adjust the tilt position of the steering wheel 3.

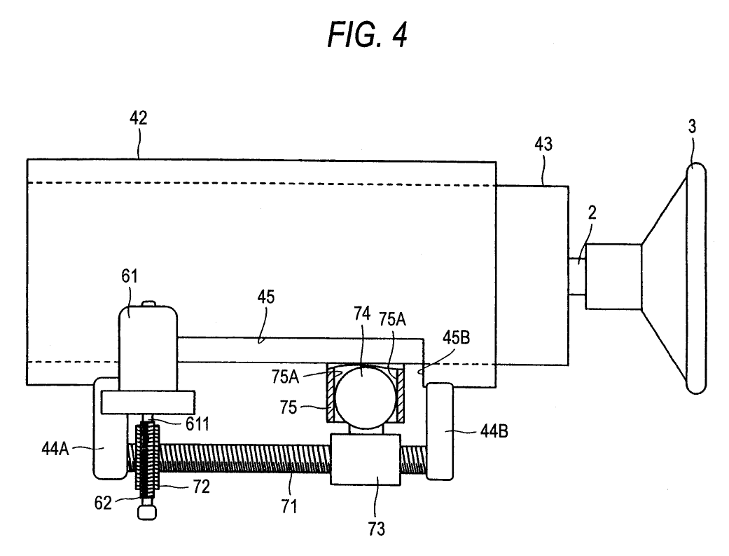

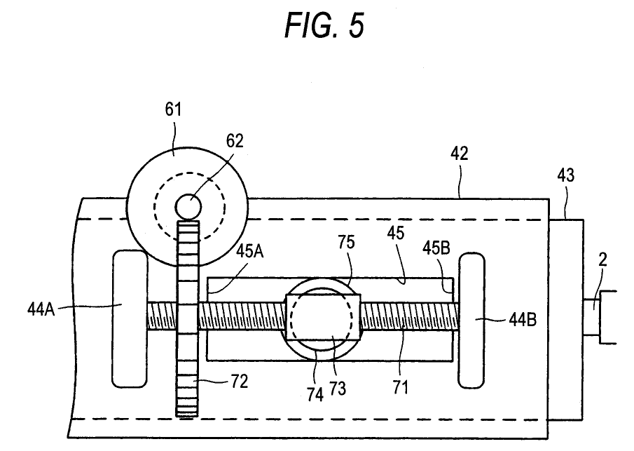

FIG. 4 shows a steering apparatus of an electric telescopic type which adjusts the telescopic position of the steering wheel 3 using an electric motor; that is, FIG. 4 is a schematic structure view of the main portions of this steering apparatus, including a section view of a portion thereof. FIG. 5 is a lower surface view of FIG. 4.

Into a hollow cylindrical-shaped outer column 42, there is fitted an inner column 43 in such a manner that it can be slided telescopically in the axial direction thereof (in the right and left direction in FIG. 4). In the lower portion of the outer column 42, there is formed a rectangular-shaped opening 45; and, a sleeve 75 fixed to the inner column 43 projects out downwardly and outwardly through this opening 45. Since the outer periphery of the sleeve 75 is contacted with the front end 45A and rear end 45B of the opening 45 in the telescopic position adjustment operation, the opening 45 functions as a stopper and also prevents the rotation of the inner column 43 in the rotation direction thereof.

On the inner column 43, there is rotatably supported a steering shaft 2 and, on the right end (on the rear side of the vehicle body) of the steering shaft 2, there is mounted a steering wheel 3. On the lower surface of the outer column 42, there are provided a front shaft support portion 44A and a rear shaft support portion 44B integrally therewith the opening 45 between them in such a manner that they project downwardly; and, on the front and rear shaft support portions 44A and 44B, there are supported the front and rear ends of a feed screw 71 through their associated antifriction bearings (not shown), respectively. Also, to the side surface of the outer column 42, there is fixed an electric motor 61.

On the output shaft 611 of the electric motor 61, there is formed a worm gear 62 integrally therewith; and, a worm wheel 72, which is fixed to the feed screw 71, is meshingly engaged with the worm gear 62. The worm wheel 72 and worm gear 62 cooperate together in constituting a reduction mechanism, whereby the rotational movement of the electric motor 61 is transmitted to the feed screw shaft 71 in a reduced manner.

With the feed screw shaft 71, there is threadedly engaged a feed nut 73 which is used to convert the rotational movement of the feed screw shaft 71 to a linear movement. On the feed nut 73, there is integrally formed a ball 74 which has a spherical-shaped projection in the upper portion thereof; and, the outer periphery of the ball 74 is slidably fitted into the inner periphery 75A of the sleeve 75, thereby constituting a spherical joint.

When there arises the need to adjust the telescopic position of the steering wheel 3, by operating a switch (not shown), the electric motor 61 is driven and rotated in either of forward or reverse direction. In response to this, the rotational movement of the electric motor 61 is transmitted from the worm gear 62 to the worm wheel 72 in a reduced manner and thus the feed screw shaft 71 formed integrally with the worm wheel 72 is caused to rotate, whereby, for example, the feed nut 73 is moved along the feed screw shaft 71 in the left direction (toward the front side of the vehicle body).

As a result of this, the ball 74 formed integrally with the feed nut 73 is also moved in the left direction and, since the ball 74 is fitted with the sleeve 75, the inner column 43 is telescopically moved in the left direction. Also, when the ball 74 is moved in the right direction (toward the rear side of the vehicle body), the inner column 43 is telescopically moved in the right direction. When the inner column 43 moves telescopically, the ball 74 is freely rotated and slided within the inner periphery 75A of the sleeve 75, thereby eliminating a fear that the telescopic movement of the inner column 43 can be blocked and unnecessary stress or friction can be generated between the ball 74 and sleeve 75.

In the above-mentioned steering apparatus of an electric telescopic type, the feed screw shaft 71 is rotated and the rotational movement of the feed screw 71 is converted to the linear movement of the feed nut 73. However, alternatively, a female screw, which is formed on the inner periphery of the worm wheel 72, may be threadedly engaged with the feed screw shaft 71, the feed nut 73 may be fixed to the feed screw 71, the rotational movement of the worm wheel 72 may be used to move the feed screw shaft 71 linearly, and thus the ball 74 may be moved in the back and forth direction of the vehicle body to thereby adjust the telescopic position of the steering wheel 3.

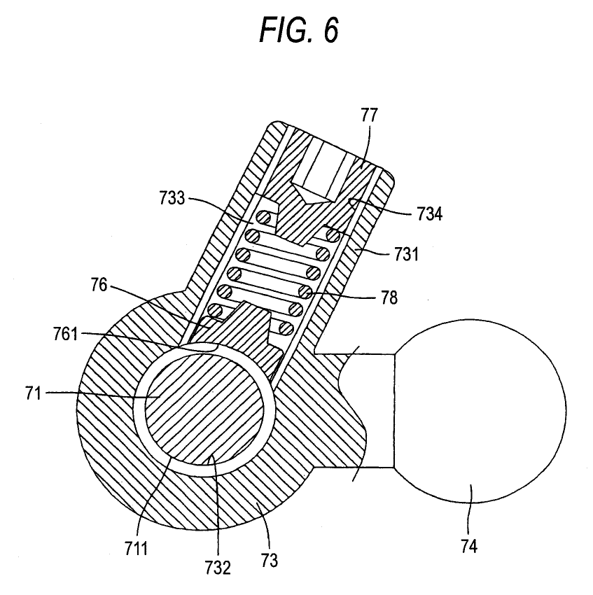

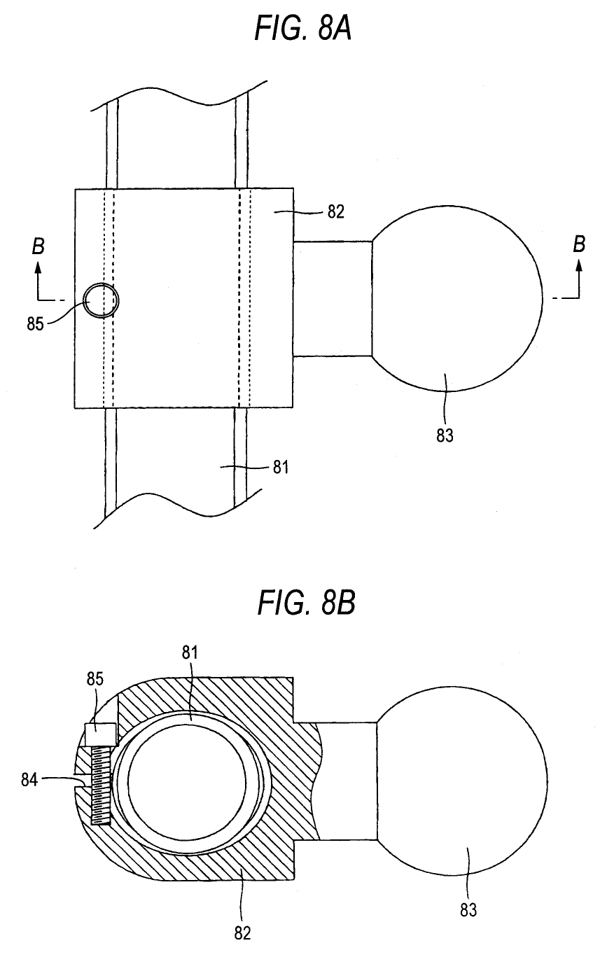

Next, description will be given below of the detailed shape of a feed screw mechanism having the feed screw shaft 71 and feed nut 73. FIG. 6 shows a main portion of a feed screw mechanism according to an embodiment 1 of the invention and corresponds to FIG. 8B.

As shown in FIG. 6, in an outer periphery of the cylindrical-shaped feed nut 73, there is formed a columnar-shaped boss portion 731 which projects outwardly in the radial direction of the feed nut 73 from the axis of the feed nut 73. In the axis of the boss portion 731, there is opened up a penetration hole 733 which has a circular section and opens in the inner diameter hole 732 of the feed nut 73; and, on the inner periphery of the penetration hole 733, there is formed a female screw 734 in such a manner that it extends over the whole length of the penetration hole 733.

Note that the inner diameter hole 732 is a through hole which penetrates the feed nut 73 in the axial direction, and a female screw which engages with a male screw of the feed screw shaft is formed on the outer periphery of the inner diameter hole 732.

Into the inner diameter hole of the female screw 734, there is inserted a columnar-shaped pressing member 76 having a diameter slightly smaller than the diameter of the inner diameter hole of the female screw 734. In the pressing member 76, there is formed an arc-shaped contact surface 761 having the same radius as the outer diameter portion 711 of the feed screw shaft 71, while the arc-shaped contact surface 761 is in contact with the outer diameter portion 711 of the feed screw shaft 71.

Into the female screw 734, there is screwed a pressing force adjusting screw 77 and, between the pressing force adjusting screw 77 and pressing member 76, there is interposed a compression coil spring 78 which functions as an elastic member. Therefore, by properly adjusting the screw-in distance of the pressing force adjusting screw 77, the arc-shaped contact surface 761 of the pressing member 76 can be pressed against the outer diameter portion 711 of the feed screw shaft 71 owing to the biasing force of the compression coil spring 78.

As a result of this, there can be removed a backlash between the feed nut 73 and feed screw shaft 71. Thanks to this, the adjustment of the telescopic position of the steering wheel 3 as well as the adjustment of the tilt position thereof can be carried out smoothly, which can enhance the rigidity of the steering wheel 3 after the position adjustment thereof.

Also, since the backlash adjusting operation is easy, and also since, even when the precision of the thread ridge of the feet nut 73 is poor, the backlash can be removed positively, the manufacturing cost of the feed screw mechanism can be reduced. Further, because, even when the feed screw shaft 71 and the feed nut 73 are worn, the backlash can be removed following such wear owing to the biasing force of the compression coil spring 78, the durability of the feed screw mechanism can be enhanced.

### Embodiment 2

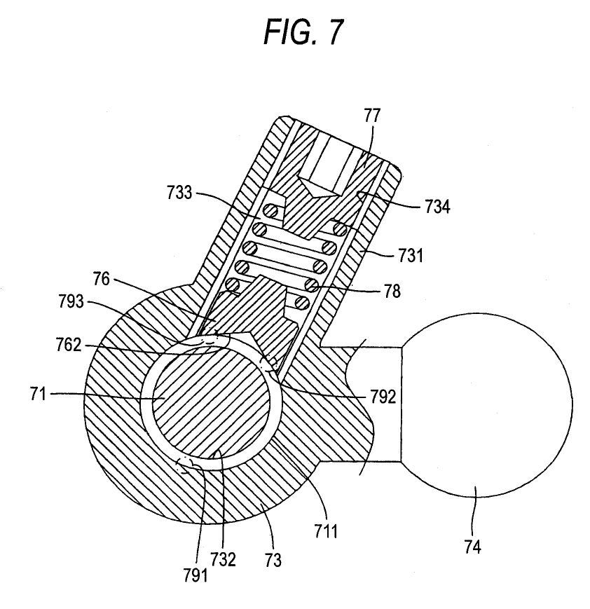

Next, description will be given below of another embodiment 2 according to the invention. FIG. 7 shows the main portions of a feed screw mechanism according to the embodiment 2 of the invention and corresponds to FIG. 8B. In the following description, only the portions of the embodiment 2, which are different from the above-mentioned embodiment 1, and the operations thereof will be described and the duplicate description of the same portions will be omitted.

The embodiment 2 shows a modification of the contact surface of the pressing member 76 with the outer diameter portion 711 of the feed screw shaft 71. In the embodiment 2, the contact surface of the pressing member 76 with the outer diameter portion 711 of the feed screw shaft 71 is formed as a V-shaped contact surface 762 which can be contacted with the outer diameter portion 711 of the feed screw shaft 71.

As shown by a circle designated by a one-dot chained line in FIG. 7, the contact surface 762 is contacted with the outer diameter portion 711 of the feed screw shaft 71 at three contact points 791, 792 and 793 to remove a backlash between the feed nut 73 and feed screw shaft 71, so that the backlash can be removed stably.

In the embodiment 2, although employing V-shaped contact surface as the contact surface 762, the present invention does not limit this V-shaped contact surface. As far as pressing the outer diameter portion 711 of the feed screw 71 stably, the shape of the contact surface 762 is not limited to. That is, it is enough that the contact surface contacts with at least two portions of the outer diameter portion 711 of the feed screw shaft 71.

Here, a phase between the ball 74 and penetration hole 733 is not limited to the above-described embodiments 1 and 2, but the ball 74 and penetration hole 733 can also be formed at arbitrary phase positions such as 45 degrees, 90 degrees, 135 degrees, 180 degrees and the like.

In the above-mentioned embodiments, as the elastic member, there is used a coil spring. However, there may also be used a disc spring, a wave washer, and a non-metallic elastic member made of rubber, resin or the like. Also, in the above embodiments, there are shown examples which are applied to a steering apparatus which carries out one of a telescopic position adjustment and a tilt position adjustment; however, the invention may also be applied to a steering apparatus which can carry out both of the telescopic position adjustment and tilt position adjustment. Further, a feed screw mechanism according to the invention can also be applied to a feed screw mechanism which is used in a machine tool and the like.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A feed screw mechanism comprising:
a feed screw shaft;
a feed nut threadedly engaged with the feed screw and moving relative to the feed screw, the feed nut comprising:
a penetration hole which penetrates the feed nut in radial direction; and
a female screw formed on an inner peripheral surface of the penetration hole;
a pressing member which is inserted into the penetration hole and abuts with an outer diameter surface of the feed screw;
a pressing force adjusting screw threadedly engaged with the female screw formed in the inner peripheral surface of the penetration hole; and
an elastic member interposed between the pressing force adjusting screw and the pressing member.

2. The steering apparatus as set forth in claim 1, wherein
the pressing member comprises an arc-shaped contact surface contactable with the outer diameter portion of the feed screw shaft.

3. The steering apparatus as set forth in claim 1, wherein
the pressing member comprises a V-shaped contact surface contactable with the outer diameter portion of the feed screw shaft.

4. The steering apparatus as set forth in claim 1, wherein
the pressing member comprises contact surfaces contactable with at least two portions of the outer diameter portion of the feed screw shaft.

5. A steering apparatus comprising:
a steering shaft to which a steering wheel is mounted at a vehicle body rear side thereof;
a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;
an electric actuator mounted on the column or on the vehicle body mounting bracket; and
the feed screw mechanism as set forth in claim 1,
wherein the feed screw mechanism is driven by the electric actuator for carrying out the tilt movement or telescopic movement of the column by using the relative movement between the threadedly engaged feed screw shaft and feed nut.

6. A steering apparatus comprising:
a steering shaft to which a steering wheel is mounted at a vehicle body rear side thereof;
a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;
an electric actuator mounted on the column or on the vehicle body mounting bracket; and
the feed screw mechanism as set forth in claim 2,
wherein the feed screw mechanism is driven by the electric actuator for carrying out the tilt movement or telescopic movement of the column by using the relative movement between the threadedly engaged feed screw shaft and feed nut.

7. A steering apparatus comprising:
a steering shaft to which a steering wheel is mounted at a vehicle body rear side thereof;
a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;
an electric actuator mounted on the column or on the vehicle body mounting bracket; and
the feed screw mechanism as set forth in claim 3,
wherein the feed screw mechanism is driven by the electric actuator for carrying out the tilt movement or telescopic movement of the column by using the relative movement between the threadedly engaged feed screw shaft and feed nut.

8. The steering apparatus as set forth in claim 7, further comprising:
a spherical-shaped ball formed in the feed nut; and
a cylindrical-shaped sleeve formed in a power transmission path of the tilting movement or telescopic movement from the electric actuator to the column,
wherein the ball is slidably fitted into the sleeve.

9. A feed screw mechanism comprising:
a feed screw shaft;
a feed nut threadedly engaged with the feed screw and moving relative to the feed screw, the feed nut comprising:
a penetration hole which penetrates the feed nut in radial direction; and
a female screw formed on an inner peripheral surface of the penetration hole; and
a pressing member which is inserted into the penetration hole and comprises a V-shaped contact surface contactable with the outer diameter portion of the feed screw shaft.

10. A steering apparatus comprising:
a steering shaft to which a steering wheel is mounted at a vehicle body rear side thereof;
a column mounted on a vehicle body through a vehicle body mounting bracket, supporting the steering shaft rotatably, and capable of adjusting tilt position with tilt center axis as a fulcrum thereof or capable of adjusting telescopic position along a center axis of the steering shaft;
an electric actuator mounted on the column or on the vehicle body mounting bracket; and
the feed screw mechanism as set forth in claim 9,
wherein the feed screw mechanism is driven by the electric actuator for carrying out the tilt movement or telescopic movement of the column by using the relative movement between the threadedly engaged feed screw shaft and feed nut.
